(19) United States
(12) Patent Application Publication
(10) Pub. No.: US 2020/0160421 A1
(43) Pub. Date: May 21, 2020

(54) PET CARE PRODUCT SUGGESTION AND SUBSCRIPTION SYSTEM AND METHOD OF USE

(71) Applicant: Sam Keil, Arlington, TX (US)

(72) Inventor: Sam Keil, Arlington, TX (US)

(21) Appl. No.: 16/192,343

(22) Filed: Nov. 15, 2018

(51) Int. Cl. G06Q 30/06; G06F 3/0484

(52) U.S. Cl. CPC G06Q 30/0629; G06F 3/04847; G06Q 30/0641; G06Q 30/0631

(57) ABSTRACT

A pet product selection system includes a network having a server and to perform one or more algorithmic functions; a database having data points associated with pet products; a computing device; a platform to be accessed via the computing device, the platform having a criteria input portal to receive a predetermined number of criteria from a user, the predetermined number of criteria relating to characteristics of a pet; the criteria is compared to the data points via the network to provide the user with a pet product suggestion. The pet product selection system includes a system and method for a smart and responsive market place of customized pet products purchased via a subscription-based or recurring model based on relevant user data input details. The marketplace contemplated can be based on a closed or open market.

### BACKGROUND

### 1. Field of the Invention

The present invention relates generally to pet product selection, and more specifically, to a simple pet product suggestion system with the ability to provide a pet product subscription based on user criteria. The system provides a smart and responsive marketplace for purchasing customized pet products, via a subscription based or recurring model based e-commerce system. The system is based on relevant and/or user defined input details and extends to pet products, including food, toys, treats, pharmaceuticals, etc.

### 2. Description of Related Art

Pet product selection is a well-known practice among pet owners. For example, FIG. 1 depicts a conventional pet product selection system 101 having a pet owner 103 examining a plurality of pet products 105a-c and purchasing one or more of the products. As shown in flowchart 201, in FIG. 2, a pet owner will go to a pet store and browse and/or examine a plurality of products, as shown with boxes 203, 205. A user will eventually either make an uneducated or arbitrary selection of a product based on the marketing, as shown with box 207.

One of the problems commonly associated with system 101 is the arbitrary selection of the pet product. For example, the user may select a product with too many calories and/or protein based on their pet's activity level. Such an inappropriate selection can lead to obesity and other health problems for the pet.

Further, during use of system 101, products are commodified in various ways and amounts, lacking in standardization. For example, a first product may last a pet owner for 12 months, whereas a second product may last the pet owner for only a single month. The lack of standardization creates friction in the shopping process and the user experience, as the user is required to work out how the otherwise arbitrarily commodified product applies to each individual pet, every time a new product is investigated.

Yet another problem with system 101 is the arbitrary pricing structure for various products within a marketplace. In the conventional method, products are priced relating to their arbitrarily form. Conversely, the pricing structure of the product options proposed through this invention are structure around a standardize pricing structure, a structure whereby products can be purchased simultaneously. The standardized pricing structure therefore creates less friction to the user.

Another problem commonly associated with system 101 is the pet owner is forced to examine irrelevant product options, thereby making system 101 greatly inefficient.

Accordingly, although great strides have been made in the area of pet product selection systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified diagram of a common pet product selection system;

FIG. 2 is a flowchart of the method of FIG. 1;

FIG. 3 is a simplified diagram of a pet product suggestion system in accordance with a preferred embodiment of the present application;

FIG. 4 is a simplified schematic of a platform of FIG. 3; and

FIG. 5 is a flowchart of the method of use of the system of FIG. 3.

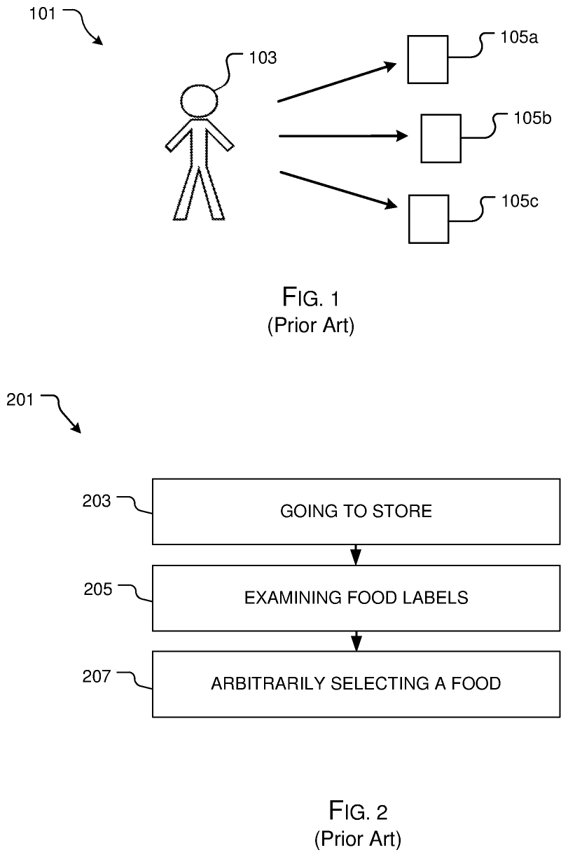

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional pet product selection systems. Specifically, the present invention provides a simple means of receiving information regarding a pet to therefore provide one or more product suggestions. The product suggestions offered are both consistent in their commoditized form and their pricing structure, responsive directly to the data input of the user's animal specifications, in effect creating a more relevant product options, and easier customer decisions. In addition, the present invention provides a subscription service based on the suggested product. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

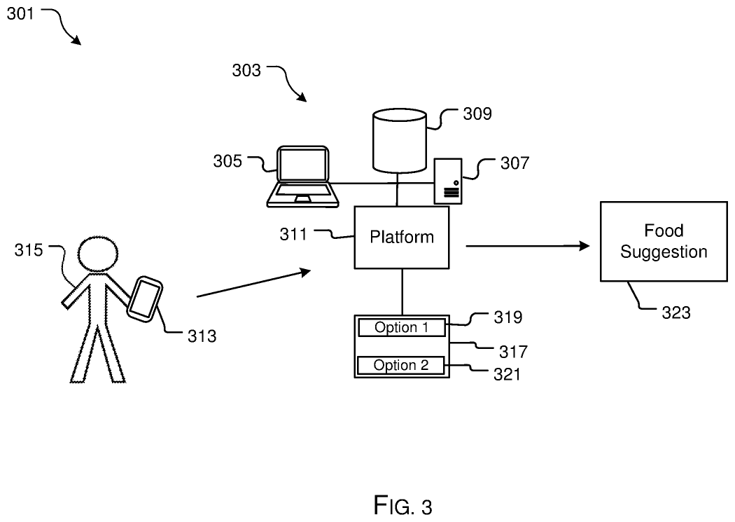

Referring now to the drawings wherein like reference characters identify corresponding or similar elements throughout the several views, FIG. 3 depicts a simplified diagram of a pet product suggestion system 301 in accordance with a preferred embodiment of the present application. It will be appreciated that system 301 overcomes one or more of the above-listed problems commonly associated with conventional pet product selection systems.

In the contemplated embodiment, system 301 includes a network 303 having one or more of a computing device 305, server 307, and database 309. It should be appreciated that network 303 is configured to receive and process information via one or more algorithms.

In the preferred embodiment, database 309 includes a plurality of data points associated with a plurality of pet products. It should be appreciated that these data points can include information such as ingredients, calories, various macro-nutrient values, various micro-nutrient values, price, and any other information. In the present application, “pet product” can be understood to mean pet food, pet toys, pet pharmaceuticals, pet treats, or any other pet product.

System 301 further includes a platform 311 configured to be accessed via a computing device 313 by a pet owner 315. Platform 311 includes a criteria input portal 317 having a predetermined number of criteria 319, 321. The criteria 319, 321 include options for the pet owner to select, thereby providing criteria for network 303 to determine an appropriate pet product selection 323. In one embodiment, the pet product selection 323 is a pre-established pet product, such as pet food being currently manufactured. In another embodiment, the pet product selection 323 is a fully customized product based on the input received from the pet owner.

In one embodiment, system 301 is configured to be accessible in an open and public marketplace, however, alternative embodiments contemplate system 301 being specifically designed for a closed and managed marketplace.

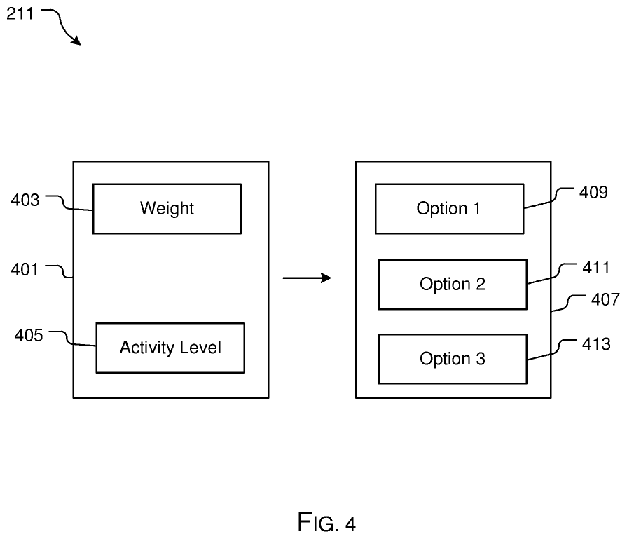

In FIG. 4, a simplified schematic of platform 311 is shown, wherein a first screen 401 provides the user with the criteria selections. In the preferred embodiment, only two selections are given, a weight selection 403 and an activity level selection 405. It should be appreciated that providing only two criteria allows for a simple and efficient system to determine the appropriate product for a pet. A pet owner can easily provide these two pieces of information to receive a pet product recommendation. It should be appreciated that more than two criteria could be added or incorporated herein.

In alternative embodiments, the criteria selection can include one or more of an animal age, an animal sex, an animal breed, or any other criteria that could be considered useful when providing the pet owner with a product suggestion.

In one contemplated embodiment, activity level selection 405 includes a sliding numerical scale, such as a selection from 1 to 10, with the various numbers representing an activity level. In another contemplated embodiment, the activity level selection 405 can include three options, namely a) normal; b) not active; and c) very active.

In one embodiment, platform 311 includes a second screen 407 configured to provide the pet owner with a plurality of options based on the suggested pet product. In this embodiment, the user is provided with product subscription options 409, 411, 413, wherein the user can sign up for a subscription service based on the product recommendation. The various options can be based on cost, amount of product, type of product, or other variables. It should be appreciated that although FIG. 4 shows three subscription options, the present invention could incorporate more or less options.

In one embodiment, subscription options 409, 411, 413 include multiple pet products, such as foods, toys, and treats, these multiple pet products being suggested based off of the pet owner input.

It should be appreciated that one of the unique features believed characteristic of the present application is the simplicity of receiving information related to a pet, to then generate a pet product suggestion. It should be appreciated that system 301 is specifically adapted to receive minimal information from a pet owner, thereby being efficient while still providing a pet product suggestion based on user input. In the pet care industry, product customization based on minimal pet owner input provides many advantages over conventional pet product purchasing. For example, the pet owner does not spend excessive amounts of time researching, reading, and talking to experts to determine the best products. Nor does the pet owner require to spend excessive amounts of time looking through pet products that do not match their pet's criteria. Further, the animal in question receives appropriate product options for their own nutritional, physiological, and psychological needs. In addition, the providing of a pet owner with a subscription service has many benefits, including limited waste, convenience, and better financial planning. The product options offered via the present system and method include a pricing structure that is relevant to a subscription-based model. The system as a whole provides for easier pet care management.

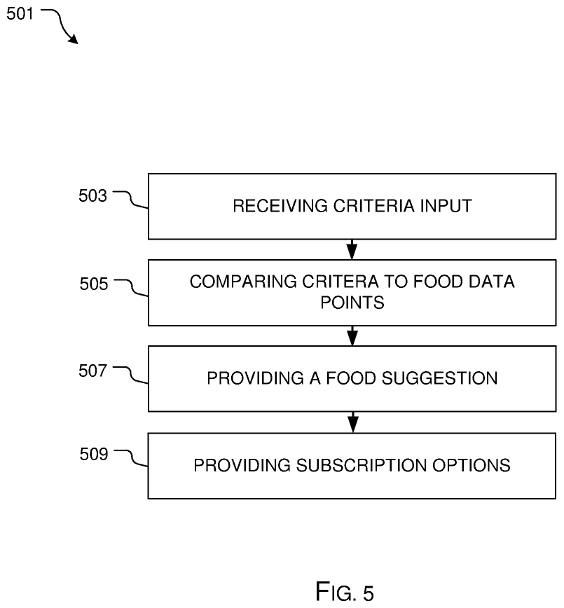

In FIG. 5, a flowchart 501 depicts a method of use of system 301. During use, the pet owner inputs information, such as pet weight and activity level into the platform, as shown with box 503. The network receives the information and compares it to data points associated with a plurality of pet products, as shown with box 505. A product suggestion is generated and provided to the pet owner, as shown with box 507. In some embodiments, the user is further presented with a plurality of product delivery subscription options, as shown with box 509.

In the present invention, by using key data point of predetermined criteria, such as pet weight and activity level, and applying these data points to make a pet product suggestion, a pet owner can effectively navigate through a marketplace (whether open or closed). The simplicity of the criteria makes for a simple user experience that reduces friction when the user is picking out one or more pet products. Further, the embodiment providing for customization of pet products provides a means to better serve a pet owner, and provide the pet owner with improved relevancy of pet product options. Furthermore, the present invention provides a means to provide a pet owner with narrowed search results of pet products, by eliminating non-relevant products according to the criteria input by the pet owner. The system and method of the present invention therefore provides pet owners with a smoother, faster shopping experience, where appropriate pet products are more relevant to the pet owner's pet, for the purpose of pet care management.

It should be appreciated that the proposed system and method of use may be used to search for products relating to single animal type categories, such as dogs or cats, as well as multiple animal categories simultaneously. Further, the preferred embodiment of the products options that are offered to the customer are not only responsive to the details entered by the pet owner, but extend to products that are standardized in terms of pricing and commodification. The products are designed specifically to fit in line with the date provided for a more efficient shopping process and friendlier user experience.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A pet product selection system, comprising:
a network having a server and configured to perform one or more algorithmic functions;
a database having a plurality of a plurality of data points;
a plurality of pet products correlating to the plurality of data points;
a computing device; and
a platform configured to be accessed via the computing device, the platform having:
a criteria input portal configured to receive a predetermined number of criteria from a user, the predetermined number of criteria relating to characteristics of a pet;
wherein the platform is responsive to the predetermined number of criteria received from the user; and
wherein the criteria is compared to the plurality of data points via the network to provide the user with a pet product suggestion.

2. The system of claim 1, wherein the predetermined number of criteria is two.

3. The system of claim 2, wherein the criteria includes:
an activity level of a pet; and
a weight of the pet.

4. The system of claim 3, wherein the activity level of the pet is represented on a sliding numerical scale for user selection.

5. The system of claim 3, wherein the activity level of the pet is represented by three choices, the three choices being:
a) normal;
b) not active; and
c) very active.

6. The system of claim 1, wherein the platform further comprises:
a pet product subscription portal having a plurality of options for the user to select a desired pet product for the pet;
wherein the plurality of options are responsive to data associated with the criteria input by the user.

7. The system of claim 6, wherein the plurality of options are commodified and priced in a standardized subscription structure, based on the data associated with the criteria input by the user.

8. The system of claim 1, wherein the platform is an open marketplace platform.

9. The system of claim 1, wherein the platform is a closed marketplace platform.

10. A method of providing a pet product to a user, the method comprising:
providing the system of claim 1;
receiving the predetermined number of criteria from the user, the criteria relating to characteristics of the pet;
comparing the predetermined number of criteria to the plurality of data points associated with the plurality of pet products; and
generating a pet product suggestion based on the comparison.

11. The method of claim 10, wherein the predetermined number of criteria is two.

12. The method of claim 11, wherein the criteria includes:
an activity level of a pet; and
a weight of the pet.

13. The method of claim 12, wherein the activity level of the pet is represented on a sliding numerical scale for user selection.

14. The method of claim 12, wherein the activity level of the pet is represented by three choices, the three choices being:
a) normal;
b) not active; and
c) very active.

15. The method of claim 10, further comprising:
providing the user with a plurality of subscription options for pet products; and
receiving a selection of one of the plurality of subscription options.

16. The method of claim 15, wherein the plurality of subscription options for pet products are responsive to data associated with the criteria input by the user.

17. The method of claim 15, wherein the plurality of subscription options for pet products are standardized in pricing and commodified nature.
